(19) United States
(12) Patent Application Publication
(10) Pub. No.: US 2026/0117810 A1
(43) Pub. Date: Apr. 30, 2026

(54) TWIST-LOCKING COUPLER SYSTEM

(71) Applicant: Nextracker LLC, Fremont, CA (US)

(72) Inventor: Kym PLOTKIN, Queensland (AU)

(21) Appl. No.: 19/370,153

(22) Filed: Oct. 27, 2025

(30) Foreign Application Priority Data
Oct. 30, 2024 (AU) 2024903528

(51) Int. Cl. F16B 7/20; E02D 27/12

(52) U.S. Cl. CPC F16B 7/20; E02D 27/12

(57) ABSTRACT

A twist-locking coupler system includes a locking hub and a first and a second tubular element. The locking hub includes a central portion having a first side and a second side. A first coupling element extends in a first direction from the first side of the central portion. A second coupling element extends in a second direction from the second side of the central portion. The second direction is opposite the first direction. The locking hub includes a tab-in-groove locking element on a first surface of the first coupling element and a tab-in-groove locking element on a first surface of the second coupling element. The first and second tubular element each receive, respectively, the first and the second coupling element in an overlapping configuration. The rotation of the locking hub about a longitudinal axis of the first and second tubular elements slides the tab-in-groove locking elements of the first and second coupling elements adjacent corresponding tab-in-groove locking elements on the first and second tubular elements, thereby coupling the locking hub to both the first and second tubular elements.

### RELATED APPLICATIONS

This application claims priority to Australian Provisional Patent Application No. 2024903528 the entire contents of which are incorporated herein by reference.

### FIELD OF THE INVENTION

The present invention relates generally to screw pile and blade pile systems. In particular, although not exclusively, the invention relates to a coupling system for effective connection between two elongated shafts.

### BACKGROUND

Screw piles and blade piles are commonly used in the construction of buildings, solar farms and other structures. A typical screw/blade pile comprises a shaft, normally made from mild steel or a higher strength steel. A helical screw or blade is attached to the shaft. In order to insert the screw pile into the ground, the screw pile is rotated and pressed downwardly, which causes the helix or blade to bite into and screw into the ground. Once the pile has been properly installed in the ground, a weight supported by the pile is distributed from the helical screw or blade into the earth that lies underneath and adjacent the screw/blade pile. Further, the overburden pressure of the earth positioned above the screw/blade assists in resisting any lifting forces applied to the pile and thereby assists in maintaining the pile in the ground.

Conventional screw/blade piles comprise a single helical screw or a pair of blades. The helical screw has a single leading edge that moves through and breaks the earth as the pile is screwed into the ground. Blade piles typically have two leading edges on the blades, which extend generally perpendicularly to the outer periphery of the blades (when viewed from above). As the shaft is normally cylindrical in shape, the leading edges of the blades may be considered to extend outwardly from the shaft in the radial direction.

Australian patent application number 2010202047 and Australian innovation US2011100820, the entire contents of which are herein incorporated by reference, describe a screw pile comprising a shaft, at least two blades extending outwardly from the shaft, each blade having a leading edge that contacts earth as the screw pile is screwed into the ground, the leading edges including at least a portion extending in a direction that is non-perpendicular to an outer periphery of the shaft (when viewed from above).

Large-scale solar energy installations typically comprise a number of solar photovoltaic cells or solar collectors (such as solar collectors that are used to heat water to produce steam). In some solar energy installations, the solar photovoltaic cells or solar collectors track the sun during the day in order to maximise the amount of solar energy collected. To enable such tracking, some installations mount a number of solar photovoltaic cells or solar collectors to large drive beams, and the drive beams are slowly rotated during the day to track the East-West movement of the sun. The drive beams and associated structure must be firmly mounted in the ground in a number of locations in order to firmly support the drive beam and stop or minimise distortion of the drive beam during use. Thus, many large-scale solar energy installations mount the supporting structure for the drive beams to concrete or driven steel beam foundations.

However, compared to such concrete or driven steel beam foundations, screw/blade piles often can be more effective and more economical as drive beam foundations. And to enable wider and more efficient applications of screw/blade pile technology, there remains a need for lighter, stronger and/or less expensive screw/blade pile designs and designs for support structures connected to screw/blade pile designs.

For example, international patent application publication WO 2023/060315 A1, titled “Solar Tracker Support System and Installation Apparatus”, discloses a solar tracker support system that includes two screw piles or blade piles inserted into the ground. Main shafts of each pile extend out of the ground and are connected to each side of an above-ground tubular “A-frame” support. Connecting the various shafts and tube elements together is generally completed using various pins or bolts.

However, coupling elements such as bolts, pins or screws for coupling solar panel support elements together can add significant costs. Large solar panel farms can require hundreds of thousands of individual blade piles, and thus even minor cost and material savings per pile can be very beneficial.

Also, robust and reliable coupling of solar panel support elements can be important to enable effective and efficient installation, operation, and removal of solar panels. For example, the ability to efficiently remove solar panel farm installations, including supporting piles and infrastructure, sometimes many years or even decades after installation, can be important for environmental site remediation.

Therefore, there is a need for further improved solar panel support designs, including improved coupling mechanisms for coupling tubular elements together.

### OBJECT OF THE INVENTION

It is an object of the present invention to overcome and/or alleviate one or more of the disadvantages of the prior art or provide the consumer with a useful or commercial choice.

### SUMMARY OF THE INVENTION

In one aspect, although it need not be the only or the broadest aspect, the invention resides in a twist-locking coupler system, comprising:
a locking hub, comprising:
   a central portion having a first side and a second side;
   a first coupling element extending in a first direction from the first side of the central portion;
   a second coupling element extending in a second direction from the second side of the central portion, wherein the second direction is opposite the first direction;
   a tab-in-groove locking element on a first surface of the first coupling element; and
   a tab-in-groove locking element on a first surface of the second coupling element; and
a first and a second tubular element that each receive, respectively, the first and the second coupling element in an overlapping configuration;
wherein rotation of the locking hub about a longitudinal axis of the first and second tubular elements slides the tab-in-groove locking elements of the first and second coupling elements adjacent corresponding tab-in-groove locking elements on the first and second tubular elements, thereby coupling the locking hub to both the first and second tubular elements.

Optionally, the locking hub further comprises at least one rotation lug positioned on an outer edge of the central portion, and a rotary position of the rotation lug about the longitudinal axis defines whether the locking hub is coupled to the first and second tubular elements or not.

Optionally, the first tubular element is connected to a support structure, and the second tubular element is a main shaft of a screw pile.

Optionally, the tab-in-groove locking elements on the first and second surfaces of the coupling elements are tabs and the tab-in-groove locking elements on the first and second tubular elements are grooves.

Optionally, the tabs extend inward from an inner surface of the coupling elements, and wherein the first and second tubular elements are received, respectively, in the first and second coupling elements.

Optionally, at least one drainage hole extends between the first or second side and an outer edge of the central portion.

Optionally, the central portion comprises two rotation lugs spaced about 180 degrees apart on the outer edge of the central portion.

Optionally, an inner diameter of the first coupling element is smaller than an inner diameter of the second coupling element.

Optionally, some of the tab-in-groove locking elements comprise both longitudinal and transverse grooves pressed into a surface of either a coupling element or a tubular element.

Optionally, the first and second tubular elements each have a pair of longitudinal and transverse grooves pressed into an external surface of each of the first and second tubular elements.

Optionally, a detent protrudes from a groove of at least one tab-in-groove locking element, enabling a “click” fit of a corresponding tab in the groove.

Optionally, the first tubular element is connected to an “A-frame” support structure, the second tubular element is a main shaft of a screw pile, and a rotary position of a pair of rotation lugs about the longitudinal axis relative to a plane of the “A-frame” support structure defines whether the locking hub is coupled to the first and second tubular elements or not.

Optionally, an internal or external diameter of the first tubular element is different from an internal or external diameter, respectively, of the second tubular element.

Optionally, the locking hub is cast as a single integral part.

In a second aspect, although it need not be the only or the broadest aspect, the invention resides in a locking hub, comprising:
a central portion having a first side and a second side;
a first coupling element extending in a first direction from the first side of the central portion;
a second coupling element extending in a second direction from the second side of the central portion, wherein the second direction is opposite the first direction;
a tab-in-groove locking element on a first surface of the first coupling element; and
a tab-in-groove locking element on a first surface of the second coupling element;
wherein each tab-in-groove locking element is configured to receive and interlock with corresponding tab-in-groove locking elements of first or second foundation components.

Optionally, the locking hub further comprises at least one rotation lug positioned on an outer edge of the central portion, and a rotary position of the rotation lug about a longitudinal axis of the first and second coupling elements defines whether the locking hub is coupled to the first and second foundation components or not.

Optionally, the first foundation component is connected to a support structure, and the second foundation component is a main shaft of a screw pile.

### BRIEF SUMMARY OF THE DRAWINGS

To assist in understanding the invention and to enable a person skilled in the art to put the invention into practical effect, preferred embodiments of the invention are described below by way of example only with reference to the accompanying drawings, in which:

FIG. 1 is a side perspective view of a locking hub, according to some embodiments of the present invention.

FIG. 2 is a side view of the locking hub of FIG. 1.

FIG. 3 is a top view of the locking hub of FIG. 1.

FIG. 4 is bottom view of the locking hub of FIG. 1.

FIG. 5 is a side cross-section view cut along the longitudinal axis of the locking hub of FIG. 1.

FIG. 6 is a side view (not shown to scale) of an “A”-frame of a solar panel support, according to some embodiments of the present invention.

FIG. 7 is a detail view “C” of the distal end of the “A”-frame of FIG. 6.

FIG. 8 is a top cross section view of the section CA-CA from FIG. 7 of the distal end of the “A”-frame of FIG. 6.

FIG. 9 is a partial side view of a fully assembled twist-locking coupler system, according to some embodiments of the present invention.

FIG. 10 is a top cross section view of section G-G of the twist-locking coupler system of FIG. 9.

### DETAILED DESCRIPTION OF THE PREFERRED EMBODIMENT

The present invention relates to a twist-locking coupler system. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, above and below, top and bottom, upper and lower, front and back, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the present invention is a twist-locking coupler system, comprising:
a locking hub, comprising:
   a central portion having a first side and a second side;
   a first coupling element extending in a first direction from the first side of the central portion;
   a second coupling element extending in a second direction from the second side of the central portion, wherein the second direction is opposite the first direction;
   a tab-in-groove locking element on a first surface of the first coupling element; and
   a tab-in-groove locking element on a first surface of the second coupling element; and
a first and a second tubular element that each receive, respectively, the first and the second coupling element in an overlapping configuration;
wherein rotation of the locking hub about a longitudinal axis of the first and second tubular elements slides the tab-in-groove locking elements of the first and second coupling elements adjacent corresponding tab-in-groove locking elements on the first and second tubular elements, thereby coupling the locking hub to both the first and second tubular elements.

Advantages of some embodiments of the present invention include a lighter and more robust coupler system for connecting together two elongated shafts, and which system can be assembled faster as separate fasteners such as screws or bolts are not required.

Also, according to some embodiments, the coupler system of the present invention enables a robust coupling even where each elongated shaft has a different internal and/or external diameter than the other elongated shaft.

Also, according to some embodiments, the locking hub further comprises at least one rotation lug positioned on an outer edge of the central portion, and a rotary position of the rotation lug about the longitudinal axis defines whether the central portion is coupled to the first and second tubular elements or not. That can provide a highly visible signal to a user that the coupling system has been assembled correctly, and enables rapid and efficient visual inspection of large numbers of systems, such as across a large solar farm.

Further, according to some embodiments, the rotation lugs function as buttresses that strengthen the sides of the first coupling element.

Further, according to some embodiments, elements of the system of the present invention can be readily fabricated by casting as integral parts, without requiring additional welding, machining or assembly.

Further, according to some embodiments, grooves of the tab-in-groove locking elements are pressed into distal ends of the first and second tubular elements, which cold works and locally strengthens steel of the distal ends of the tubular elements.

Also, according to some embodiments, one or more drainage holes extend between the first or second side and an outer edge of the central portion, enabling lower tubular elements to be sealed from moisture and resist corrosion.

Those skilled in the art will appreciate that not all of the above advantages are necessarily included in all embodiments of the present invention.

FIG. 1 is a side perspective view of a locking hub 100, according to some embodiments of the present invention. The locking hub 100 includes a central portion in the form of a central plate 105, and hollow first and second coupling elements 110, 115, respectively, that are shown extending upwards and downwards from the central plate 105. A locking tab 120a extends inward from an internal wall of the first coupling element, the tab 120a forms part of a tab-in-groove locking element and enables the locking hub 100 to be efficiently coupled to a first tubular element (see, e.g., FIG. 6).

A drainage hole 125a is shown on an outer edge of the central plate 105, and enables water to flow from an internal cavity defined by the first coupling element 110 and out of the drainage hole 125a. Also, a first rotation lug 130a is positioned on the outer edge of the central plate 105. As described in further detail below, a rotary position of the rotation lug 130a about a longitudinal axis (which extends up and down the page of FIG. 1 through a center of the locking hub 100) can define whether the locking hub 100 is properly coupled or not to the first and second tubular elements.

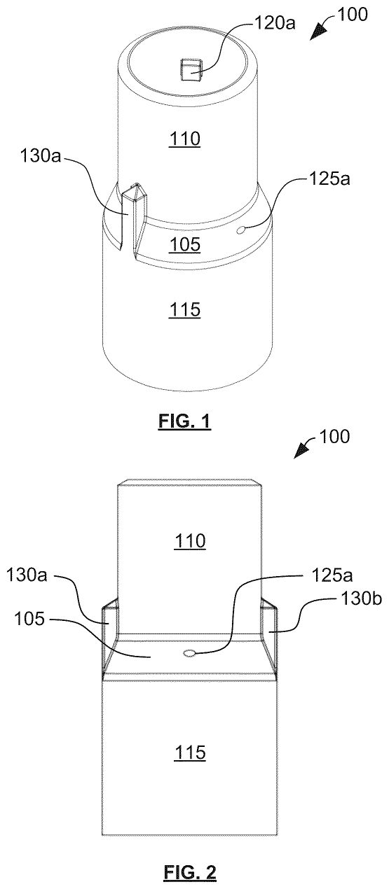

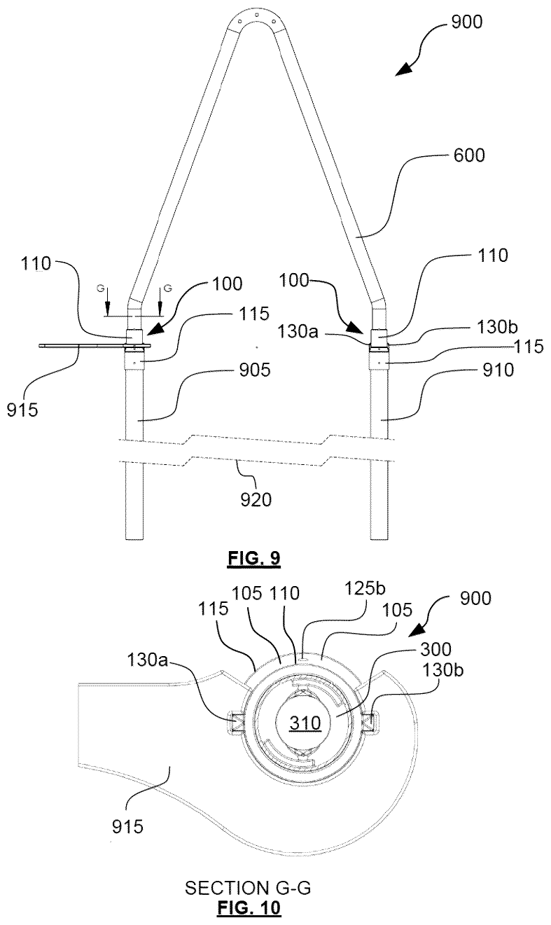

FIG. 2 is a side view of the locking hub 100. A second rotation lug 130b is spaced 180 degrees away from the first rotation lug 130a around the longitudinal axis, and the pair of rotation lugs 130a, 130b enable the application of balanced torque to be applied by an installation wrench (see, e.g., FIGS. 9 and 10) when securing the locking hub 100 to first and second tubular elements.

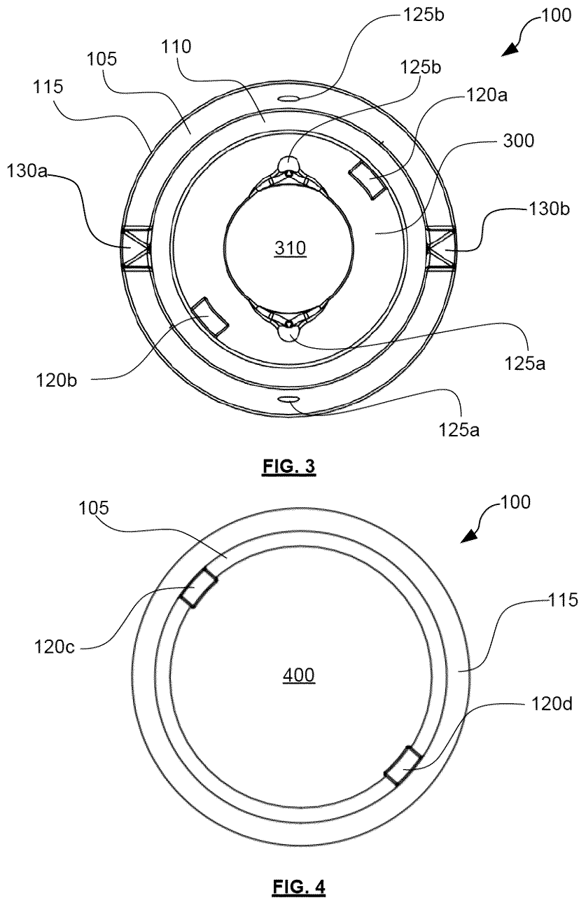

FIG. 3 is a top view of the locking hub 100. A first side 300 (i.e., top side) of the central plate 105 is shown at a bottom of the first coupling element 110. Further, a second locking tab 120b is shown spaced 180 degrees away from the first locking tab 120a around the longitudinal axis (which extends into and out of the page at the center of FIG. 3). Also, a second drainage hole 125b is shown spaced 180 degrees away from the first drainage hole 125a around the longitudinal axis. An elevated portion 310 in the middle of the central plate 105 assists in directing water into entrance points of the first and second drainage holes 125a, 125b.

FIG. 4 is bottom view of the locking hub 100. Third and fourth locking tabs 120c, 120d are shown extending inward from an internal surface of the second coupling element 115. A second side 400 (i.e., bottom side) of the central plate 105 is also shown.

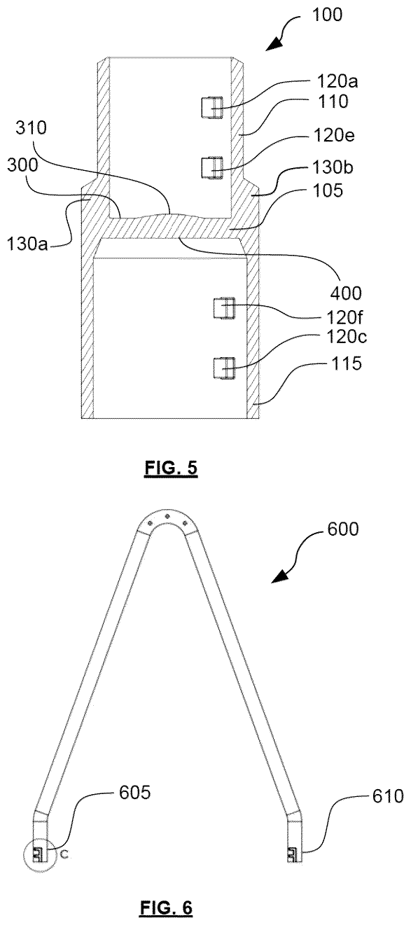

FIG. 5 is a side cross-section view cut along the longitudinal axis of the locking hub 100. Additional locking tabs 120e, 120f are shown extending inward from the internal surfaces of the first and second coupling elements 110, 115, respectively.

FIG. 6 is a side view (not shown to scale) of an “A”-frame 600 of a solar panel support, according to some embodiments of the present invention. Distal ends 605, 610 of the tubular elements that form the “A”-frame 600 are each receivable in a locking hub 100.

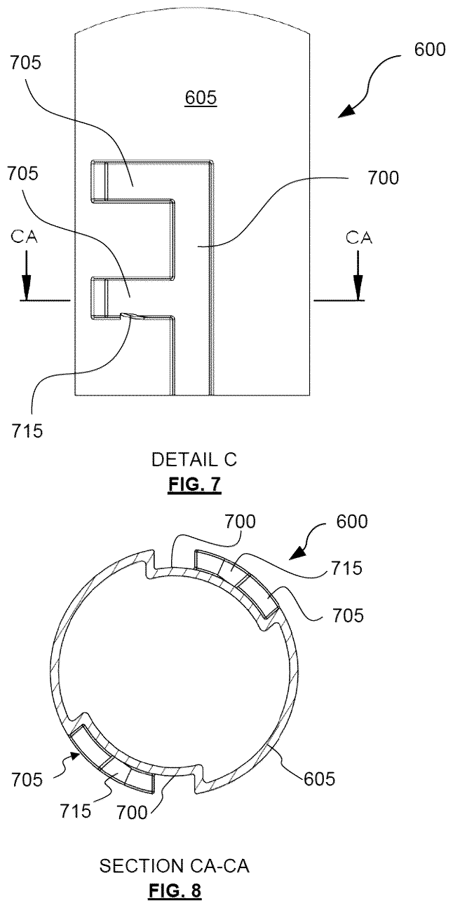

FIG. 7 is a detail view “C” of the distal end 605 of the “A”-frame 600. A longitudinal groove 700 connects to two transverse grooves 705. The grooves 700, 705 are each pressed into the surface of the tubular elements of the “A”-frame. Such pressing can cold work the steel around the grooves 700, 705, and thus add additional strength to the grooves 700, 705.

Each tab 120a to 120f and an adjacent groove 700, 705 thus functions as a tab-in-groove locking element that can prevent relative rotation and longitudinal translation between the locking hub 100 and first and second tubular elements received in the locking hub 100.

For example, during attachment of the “A”-frame 600 to a pair of vertical supports (see FIG. 9), the hollow interior of a first coupling element 110 of a locking hub 100 receives the distal end 605 of the “A”-frame 600. The tab 120b and another tab (not shown, but opposite tab 120e) slide into the longitudinal groove 700 and are stopped when the tab 120b contacts the top end 710 of the longitudinal groove 700. Similarly, tabs 120a, 120e on the opposite side of the first coupling element 110 also slide into a respective longitudinal groove (as shown in FIG. 8) pressed into the back side of the distal end 605.

Next, the second coupling element 115 of the locking hub 100 receives a second tubular element, such as the top main shaft of a screw pile (see FIG. 9). A distal end (not shown) of the top of the screw pile also includes longitudinal and transverse grooves, which mirror about the horizontal axis the longitudinal and transverse grooves 700, 705 of the distal end 605 of the “A”-frame 600. The locking tabs 120f, 120d and a corresponding pair of tabs 120c and another tab (not shown, but opposite tab 120f) all slide to the bottom of the longitudinal groove on the screw pile.

Finally, a simple counter clockwise rotation of 45 degrees of the locking hub 100 robustly couples the locking hub 100 to both the “A”-frame 600 and to the screw pile. Such a rotation of the locking hub 100 causes all eight locking tabs 120a, etc., to slide simultaneously in their respective eight transverse grooves 705. Four of the inner-most tabs 120e, 120f, etc. first contact a detent 715 positioned on each of four of the transverse grooves 705. Further rotation of the tabs 120e, 120f, etc. past the detents 715, generates an audible and/or haptic “click” that indicates that the locking hub 100 is secured in its final position.

FIG. 8 is a top cross section view of the section CA-CA from FIG. 7 of the distal end 605 of the “A”-frame 600. The pressed longitudinal and transverse grooves 700, 705 are shown as generally maintaining the original material thickness of the tubular “A”-frame 600, which assists in maintaining the original rigidity and strength of the “A”-frame 600.

FIG. 9 is a partial side view of a fully assembled twist-locking coupler system 900, according to some embodiments of the present invention. Two locking hubs 100 are shown connected to the distal ends 605, 610, respectively, of the “A”-frame 600. Further, the top main shafts 905, 910 of two screw piles are shown connected to the second coupling elements 115 of the locking hubs 100. Also, a custom wrench 915 is shown fitted over the rotation lugs 130a, 130b of the left side locking hub 100.

Dashed lines 920 indicate that the main shafts 905, 910 can be of indefinite length. As will be understood by those skilled in the art, lower portions of the main shafts 905, 910 are not shown and are generally screwed into the ground to provide rigid support for the “A”-frame 600.

The assembled locking hub 100 shown on the right side of FIG. 9 illustrates how the two rotation lugs 130a, 130b, when fully tightened against both the distal end 610 of the “A”-frame 600 and the distal top end of the main shaft 910, function as clearly visible flags for any inspection of the completed twist-locking coupler system 900. Namely, the parallel alignment of the rotation lugs 130a, 130b with the plane of the “A”-frame 600 (which is generally East-West in a solar farm installation) clearly indicates that the system 900 has been securely and correctly assembled. Further, in this orientation, the rotation lugs 130a, 130b also function as effective buttresses that strengthen the first coupling element 110 against considerable East-West wind loads that may be applied to supported solar panels.

FIG. 10 is a top cross section view of section G-G from FIG. 9 of the twist-locking coupler system 900. The custom wrench 915 is shown fitted over the rotation lugs 130a, 130b and resting on the external shoulder of the central plate 105.

Those skilled in the art will appreciate that embodiments of the present invention can be manufactured from a wide range of materials, including sand-cast or die-cast steel.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above-described invention.

We claim:

1. A twist-locking coupler system, comprising:
a locking hub, comprising:
a central portion having a first side and a second side;
a first coupling element extending in a first direction from the first side of the central portion;
a second coupling element extending in a second direction from the second side of the central portion, wherein the second direction is opposite the first direction;
a tab-in-groove locking element on a first surface of the first coupling element; and
a tab-in-groove locking element on a first surface of the second coupling element; and
a first and a second tubular element that each receive, respectively, the first and the second coupling element in an overlapping configuration;
wherein rotation of the locking hub about a longitudinal axis of the first and second tubular elements slides the tab-in-groove locking elements of the first and second coupling elements adjacent corresponding tab-in-groove locking elements on the first and second tubular elements, thereby coupling the locking hub to both the first and second tubular elements.

2. The system of claim 1, wherein locking hub further comprises at least one rotation lug positioned on an outer edge of the central portion, and a rotary position of the rotation lug about the longitudinal axis defines whether the locking hub is coupled to the first and second tubular elements or not.

3. The system of claim 1, wherein the first tubular element is connected to a support structure, and the second tubular element is a main shaft of a screw pile.

4. The system of claim 1, wherein the tab-in-groove locking elements on the first and second surfaces of the coupling elements are tabs and the tab-in-groove locking elements on the first and second tubular elements are grooves.

5. The system of claim 1, wherein the tabs extend inward from an inner surface of the coupling elements, and wherein the first and second tubular elements are received, respectively, in the first and second coupling elements.

6. The system of claim 1, wherein at least one drainage hole extends between the first or second side and an outer edge of the central portion.

7. The system of claim 2, wherein the central portion comprises two rotation lugs spaced about 180 degrees apart on the outer edge of the central portion.

8. The system of claim 1, wherein an inner diameter of the first coupling element is smaller than an inner diameter of the second coupling element.

9. The system of claim 1, wherein some of the tab-in-groove locking elements comprise both longitudinal and transverse grooves pressed into a surface of either a coupling element or a tubular element.

10. The system of claim 1, wherein the first and second tubular elements each have a pair of longitudinal and transverse grooves pressed into an external surface of each of the first and second tubular elements.

11. The system of claim 1, wherein a detent protrudes from a groove of at least one tab-in-groove locking element, enabling a “click” fit of a corresponding tab in the groove.

12. The system of claim 2, wherein the first tubular element is connected to an “A-frame” support structure, the second tubular element is a main shaft of a screw pile, and a rotary position of a pair of rotation lugs about the longitudinal axis relative to a plane of the “A-frame” support structure defines whether the locking hub is coupled to the first and second tubular elements or not.

13. The system of claim 1, wherein an internal or external diameter of the first tubular element is different from an internal or external diameter, respectively, of the second tubular element.

14. The system of claim 1, wherein the locking hub is cast as a single integral part.

15. A locking hub, comprising:
a central portion having a first side and a second side;
a first coupling element extending in a first direction from the first side of the central portion;
a second coupling element extending in a second direction from the second side of the central portion, wherein the second direction is opposite the first direction;
a tab-in-groove locking element on a first surface of the first coupling element; and
a tab-in-groove locking element on a first surface of the second coupling element;
wherein each tab-in-groove locking element is configured to receive and interlock with corresponding tab-in-groove locking elements of first or second foundation components.

16. The locking hub of claim 15, further comprising at least one rotation lug positioned on an outer edge of the central portion, and a rotary position of the rotation lug about a longitudinal axis of the first and second coupling elements defines whether the locking hub is coupled to the first and second foundation components or not.

17. The system of claim 1, wherein the first foundation component is connected to a support structure, and the second foundation component is a main shaft of a screw pile.
